(19) United States
(12) Patent Application Publication
(10) Pub. No.: US 2006/0139511 A1
(43) Pub. Date: Jun. 29, 2006

(54) Liquid crystal panel backlight module

(75) Inventors: Wen-Pao Tseng, Yangmei Taoyuan (TW); Hsin-Chien Chiang, Yangmei Taoyuan (TW); Yu-Hsiu Chiang, Yangmei Taoyuan (TW)

Correspondence Address: TROXELL LAW OFFICE PLLC, SUITE 1404, 5205 LEESBURG PIKE, FALLS CHURCH, VA, 22041, US

(73) Assignee: K-Bridge Electronics Co., Ltd.

(21) Appl. No.: 11/023,563

(22) Filed: Dec. 29, 2004

(51) Int. Cl. G02F 1/1335

(52) U.S. Cl. 349/64

(57) ABSTRACT

An LCD backlight module construction has a reflector that gives light reflection and transmission features disposed at where the light is emitted from each light source for light diffused from both sides of the light source to be consistently diffused towards the diffuser after proper reflection and transmission through the reflector thus to eliminate the dim areas between light sources for providing effective solution to the problem of developing the light and shade bands found with the prior art.

### BACKGROUND OF THE INVENTION

(a) Field of the Invention

The present invention is related to a construction of a liquid crystal panel backlight module, and more particularly to one that effectively distribute the light emitted from the light source without causing light and shade bands.

(b) Description of the Prior Art

Referring to FIG. 1 of the accompanying drawings for a sectional view of a construction of a backlight module of the prior art, the backlight module generally adapted to a liquid crystal module includes in sequence from inner side to outer side a reflection mask 10, multiple light sources 20, a diffuser 30, an optimal film 40 comprised of a lower sheet diffuser, a prism, a deflector or an upper sheet diffuser, and a liquid crystal panel 50. Each light source 20 may be made in the form of a straight tube, U-shaped tube or a tube with continuous curvatures, and all light sources are arrange at a given spacing between the reflector mask 10 and the diffuser 30. The display effects of the liquid crystal module are comprised of beams emitted from those multiple light sources 20. Wherein, the beams passing through the diffuser 30 and the optical film 40 are diffused to correct the light and shade bands on the liquid crystal module due to the absence of light emitted from where between any two abutted light sources 20.

However, the diffuser 30 only helps consistent diffusion of light and has very limited effects to correct the phenomenon of light and shade bands on the liquid crystal module. Therefore, an improvement is made in some backlight modules to extend on purpose the spacing between the light sources 20 and the diffuser 30 to create a larger space for the beams from each light source 20 to enter into the diffuser 30 hopefully to reduce the light and shade bands. However, the result is very limited; and the design is also contradictory to a compact design since the backlight module has to be made thicker for the extra range between the light source 20 and the diffuser 30.

Another improvement involves the light diminishing process. That is, ink containing SiO₂ or TiO₂ is printed on the diffuser for the surface of the diffuser to provide light diminish (astigmatism) function for reducing the area of the light and shade bands. However, this improvement not only increases the production cost of the diffuser, makes the process more complicated, but also presents a passive way to eliminate the significant light and shade bands found on the liquid crystal module of the prior art since the light diminishing function is commenced only after the light reaches on the surface of the diffuser.

### SUMMARY OF THE INVENTION

The primary purpose of the present invention is to provide a more active means to eliminate the light and shade bands developed among multiple light sources in a liquid crystal backlight module while effectively distribute beams from the light sources. To achieve the purpose, a reflector that reflects and transmits light is disposed at where the beams are emitted from light sources so that beams diffused from both sides of each light source are properly reflected and transmitted through the reflector backwards and consistently to diffuse toward the diffuser.

### BRIEF DESCRIPTION OF THE DRAWINGS

FIG. 1 is a sectional view of a backlight module of the prior art.

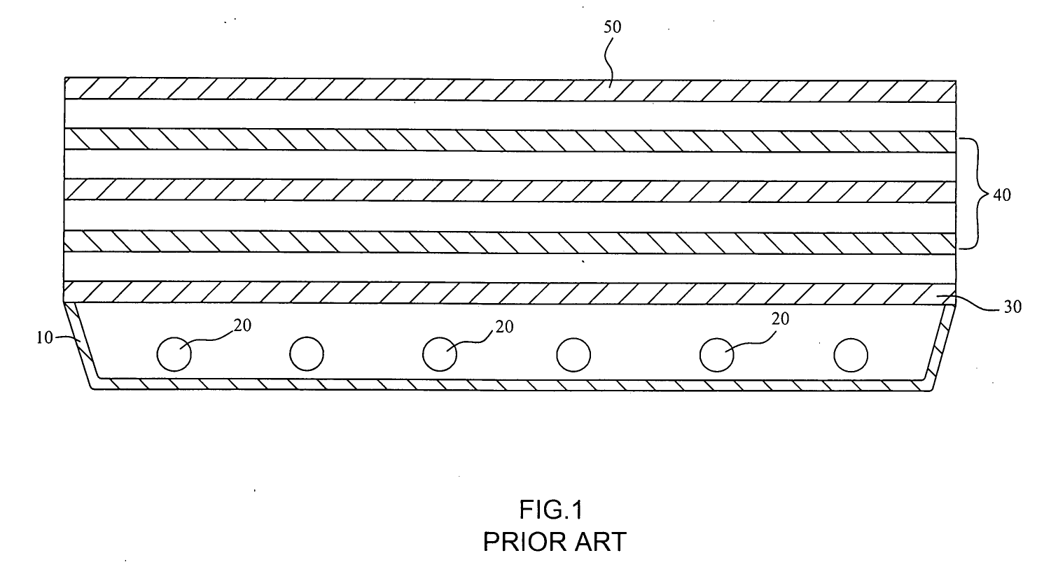

FIG. 2 is a sectional view of a backlight module of the present invention.

FIG. 3 is a schematic view showing the travel route of the light in the backlight module of the present invention.

FIG. 4 is another sectional view of the backlight module of the present invention.

FIG. 5 is another sectional view yet of the backlight module of the present invention.

### DETAILED DESCRIPTION OF THE PREFERRED EMBODIMENTS

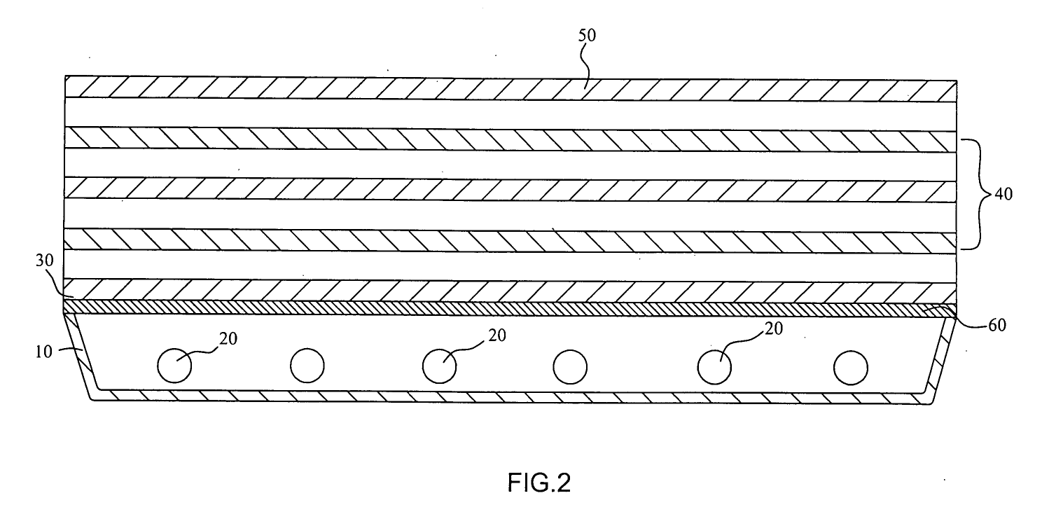

Referring to FIG. 2 for a basic configuration of a backlight module of the present invention, similar to that of the prior art, the backlight module of the present invention also includes in sequence from inner side to outer side a reflection mask 10, multiple light sources 20, a diffuser 30, an optimal film 40 comprised of a lower sheet diffuser, a prism, a deflector or an upper sheet diffuser, and a liquid crystal panel 50. Each light source 20 may be made in the form of a straight tube, U-shaped tube or a tube with continuous curvatures, and all light sources are arrange at a given spacing between the reflector mask 10 and the diffuser 30. The display effects of the liquid crystal module are comprised of beams emitted from those multiple light sources 20.

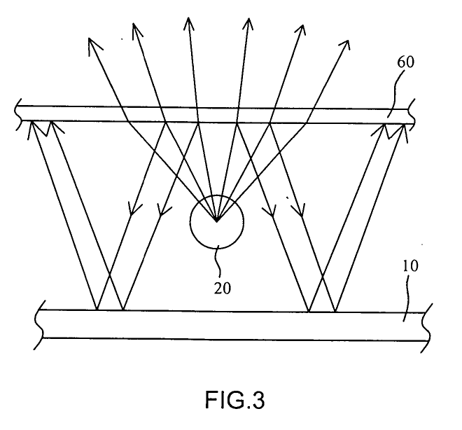

The present invention is characterized by having a reflector 60 capable of reflecting and transmitting light disposed at where beams are emitted from each light source 20. As illustrated in FIG. 2 for a sectional view of a preferred embodiment of the present invention, the reflector is disposed between the diffuser and those light sources 20 for the light diffused from both sides of each light source 20 to be reflected and transmitted through the reflector 60. The light transmitted above the light source 20 has a comparatively higher reflectivity but a lower transmittance; on the contrary, the light between abutted light sources 20 has a lower reflectivity and a higher transmittance as illustrated in FIG. 3. Accordingly, while achieving more effective light distribution, the present invention provides a positive means to eliminate the light and shade bands developed on the liquid crystal module due to the absence of light at where between any abutted light sources 20

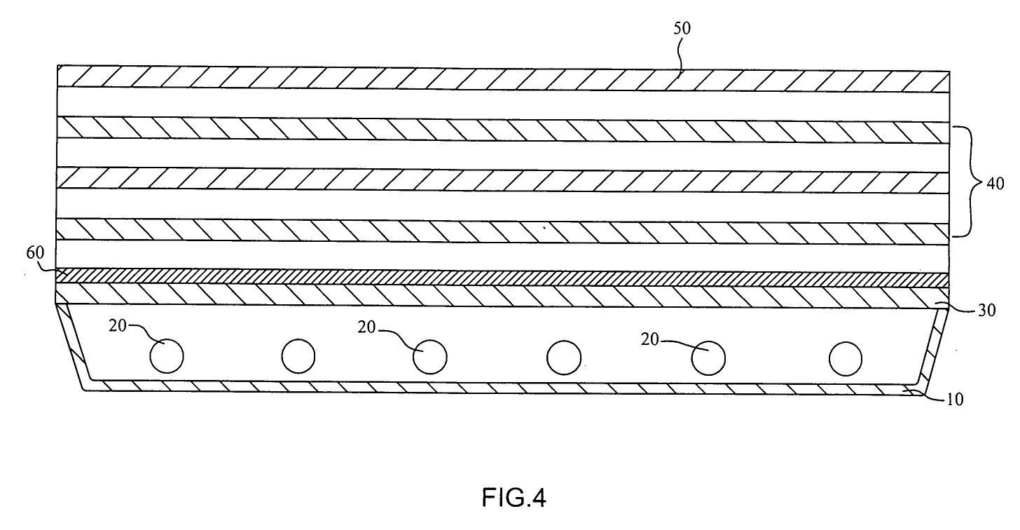

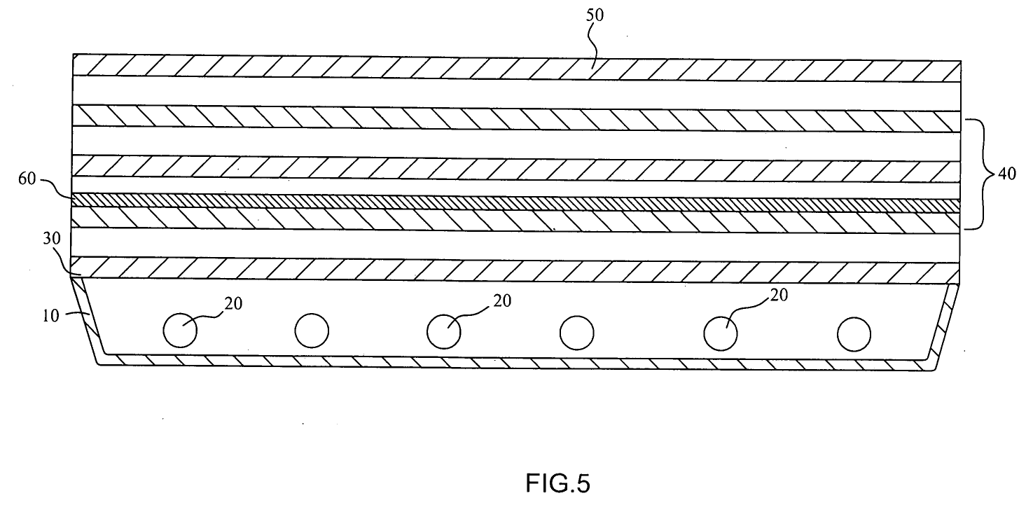

It can be appreciated that the reflector 60 may be disposed between the diffuser 30 and the optical film 40 as illustrated in FIG. 4, or between any abutted optical films 40 as illustrated in FIG. 5 to achieve the same purpose of eliminating the light and shade bands developed on the liquid crystal module.

The prevent invention provides an improved construction of a liquid crystal panel backlight module, and the application for a utility patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A liquid crystal panel backlight module includes in sequence from within out a reflector mask, multiple light sources, diffuser, multiple optical films, and a liquid crystal panel; wherein, each light source related to a straight tube, a U-shaped tube, or any other tube with continuous curvatures disposed at proper spacing at where between the reflector mask and the diffuser; a reflector capable of reflecting and transmitting light being disposed at where the light is emitted from each light source; and light diffused from both sides of each light source being properly reflected and transmitted by the reflector to effectively and consistently distribute and diffuse the light.

2. The liquid crystal panel backlight module of claim 1, wherein the reflector is disposed between the diffuser and those multiple light sources.

3. The liquid crystal panel backlight module of claim 1, wherein the reflector is disposed between the diffuser and any of the optical film.

4. The liquid crystal panel backlight module of claim 1, wherein the reflector is disposed between any two abutted optical films.
